(19) United States
(12) Patent Application Publication
(10) Pub. No.: US 2026/0032342 A1
(43) Pub. Date: Jan. 29, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventors: TOMOMI MOGAMI, Kanagawa (JP); SHIMPEI ITAGAKI, Tokyo (JP)

(21) Appl. No.: 19/250,497

(22) Filed: Jun. 26, 2025

(30) Foreign Application Priority Data
Jul. 23, 2024 (JP) 2024-117749

(51) Int. Cl. H04N 23/68; H04N 23/73; H04N 23/81

(52) U.S. Cl. CPC H04N 23/682; H04N 23/73; H04N 23/81

(57) ABSTRACT

Control apparatuses, image pickup apparatuses, control methods, and storage media are provided herein. One or more control apparatuses includes one or more memories storing instructions, and one or more processors that, upon execution of the instructions, operate to control a first image stabilizing unit and a second image stabilizing unit, and select whether to perform a specific operation using the first image stabilizing unit or the second image stabilizing unit according to an exposure time.

### BACKGROUND

### Field of the Technology

The present disclosure relates to one or more embodiments of a control apparatus, an image pickup apparatus, a control method, and a storage medium.

### Description of the Related Art

Conventionally, image pickup apparatuses are known in which a plurality of image stabilizing units are moved in coordination to enhance an image stabilizing effect. The image stabilizing units are often used for purposes other than image stabilization. For example, the image stabilizing units are used for super-resolution imaging in which resolving power is enhanced by moving the image stabilizing units by a minute amount less than one pixel and combining images, or for low-pass filer (LPF) drive in which an optical LPF effect is achieved by moving the image stabilizing units by a minute amount to allow object light beams to enter a plurality of pixels of an image sensor.

Japanese Patent Application Laid-Open No. 2020-96301 discloses a method of performing image stabilization and pixel-shift super-resolution using a drive unit for performing pixel shifting and a corrector for performing image stabilization. Japanese Patent Application Laid-Open No. 2022-011043 discloses a method of determining which image stabilizing unit to use for image stabilization by comparing, for example, power consumptions of a plurality of image stabilizing units in performing LPF drive using the image stabilizing unit.

However, the method disclosed in Japanese Patent Application Laid-Open No. 2020-96301 is silent about the characteristic of the drive unit and the corrector, which potentially results in insufficient stroke. In the method disclosed in Japanese Patent Application Laid-Open No. 2022-011043, favorable performance is potentially not achieved when the determination is made based only on power consumption.

### SUMMARY

One or more embodiments of a control apparatus according to one or more aspects of the present disclosure may include one or more memories storing instructions, and one or more processors that, upon execution of the instructions, operate to control a first image stabilizing unit and a second image stabilizing unit, and select whether to perform a specific operation using the first image stabilizing unit or the second image stabilizing unit according to an exposure time. One or more image pickup apparatuses may include the above one or more control apparatuses in accordance with one or more other aspects of the present disclosure. One or more control methods corresponding to the above one or more control apparatuses also constitutes another aspect of the present disclosure. A storage medium storing a program that causes a computer to execute the above one or more control methods also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a central sectional view and a block diagram illustrating an electrical configuration of an imaging system according to each embodiment.

FIG. 2 is an exploded perspective view of an image stabilizing mechanism according to each embodiment.

FIG. 3A is a flowchart illustrating processing according to a first embodiment.

FIG. 3B is a flowchart illustrating processing according to the first embodiment.

FIG. 3C is a flowchart illustrating processing according to the first embodiment.

FIGS. 4A and 4B are explanatory diagrams of an LPF operation according to a second embodiment.

FIGS. 5A and 5B explain the LPF operation according to the second embodiment.

FIG. 6 is a flowchart illustrating processing according to the second embodiment.

FIG. 7 is a flowchart illustrating processing according to a third embodiment.

FIG. 8 is a flowchart illustrating processing according to a fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. According to the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure.

### First Embodiment

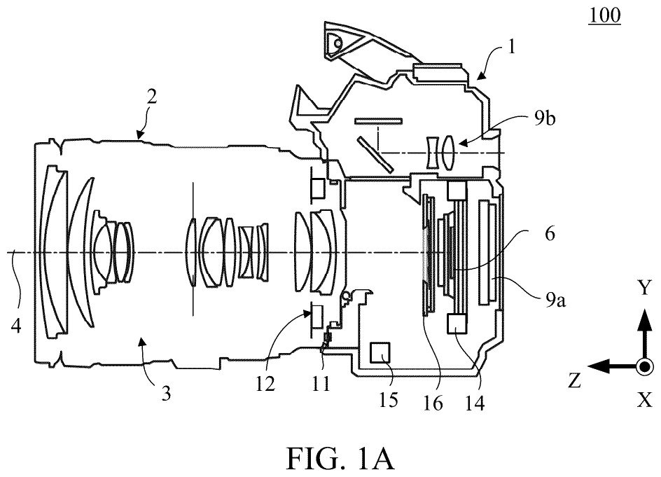

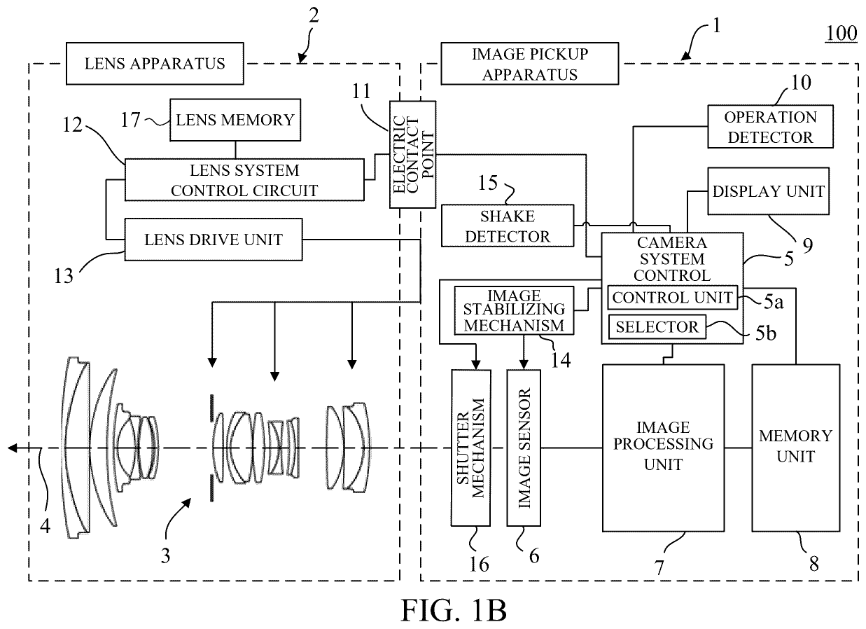

First, an imaging system (camera system) 100 according to a first embodiment of the present disclosure will be described below with reference to FIGS. 1A and 1B. FIG. 1A is a central sectional view of the imaging system 100, and FIG. 1B is a block diagram illustrating an electrical configuration of the imaging system 100. Components denoted by the same reference numerals in FIGS. 1A and 1B correspond to each other.

In FIGS. 1A and 1i, reference numeral 1 denotes an image pickup apparatus (camera body), reference numeral 2 denotes a lens apparatus (interchangeable lens) mounted on the image pickup apparatus 1, reference numeral 3 denotes an imaging optical system including a plurality of lenses, reference numeral 4 denotes an optical axis of the imaging optical system 3, reference numeral 6 denotes an image sensor, and reference numeral 9a denotes a rear display apparatus. Reference numeral 9b denotes an electronic viewfinder (EVF), reference numeral 11 denotes an electric contact point between the image pickup apparatus 1 and the lens apparatus 2, reference numeral 12 denotes a lens system control unit provided in the lens apparatus 2, reference numeral 14 denotes an image stabilizing mechanism, reference numeral 15 denotes a shake detector, and reference numeral 16 denotes a shutter mechanism, and reference numeral 17 denotes a lens memory.

In this embodiment, the lens apparatus 2 is attachable to and detachable from the image pickup apparatus 1, but the present disclosure is not limited to this example and is also applicable to an imaging system in which a lens apparatus and an image pickup apparatus are integrated. This is similarly applicable to another embodiment.

The imaging system 100 includes the image pickup apparatus 1 and the lens apparatus 2. More specifically, the imaging system 100 includes an imaging unit, an image processing unit, a recording/playback unit, and a control unit. The imaging unit includes the imaging optical system 3, the image sensor 6, and the shutter mechanism 16. The image processing unit includes an image processing unit 7. The recording/playback unit includes a memory unit 8 and a display unit 9 (the rear display apparatus 9a and the EVF 9b). The control unit includes a camera system control circuit (control apparatus) 5, an operation detector 10, the lens system control circuit 12, a lens drive unit 13, the image stabilizing mechanism 14, and the shake detector 15. The lens drive unit 13 can drive a focus lens, an image stabilizing lens, an aperture stop, and the like. The image stabilizing mechanism 14 and the lens drive unit 13 each constitute at least one of a first image stabilizing unit or a second image stabilizing unit.

The shake detector 15 can detect rotation shake of the imaging system including 100 including rotation about the optical axis 4 and may be a vibration gyro or the like. The image stabilizing mechanism 14 is a mechanism configured to translate the image sensor 6 in a plane orthogonal to the optical axis 4 and rotate the image sensor 6 about the optical axis 4. This specific structure will be described later.

The imaging unit is an optical processing system configured to image light from an object onto an imaging surface of the image sensor 6 through the imaging optical system 3. Since a focus evaluation amount and a proper exposure amount are obtained from the image sensor 6, the imaging optical system 3 is properly adjusted based on this signal to expose the image sensor 6 to a proper amount of object light and form an object image near the image sensor 6. The shutter mechanism 16 controls whether the object image reaches the image sensor 6 by moving a shutter curtain. The shutter mechanism 16 is controlled based on an exposure time (shutter speed) commanded by the camera system control circuit 5.

The image processing unit 7 includes inside an A/D converter, a white balance adjustment circuit, a gamma correction circuit, an interpolation calculation circuit, and the like and can generate an image for recording. The image processing unit 7 includes an alignment unit and an image combination unit (not illustrated). Their specific operations will be described later. The image processing unit 7 performs compression of images, moving images, audio, and the like using a predetermined method. The memory unit 8 includes a memory for storing images. The camera system control circuit 5 performs outputting to a recorder in the memory unit 8 and displays images to be presented to a user on the display unit 9.

The camera system control circuit 5 generates and outputs timing signals and the like during imaging. Each of an imaging system, an image processing system, and a recording/playback system is controlled in response to external operations. For example, the press-down of an unillustrated shutter release button is detected by the operation detector 10, and the drive of the image sensor 6, the operation of the image processing unit 7, compression processing, and the like are controlled. The camera system control circuit 5 includes an alignment turning on-off unit and an image combination turning on-off unit for turning on and off operations of the alignment unit and the image combination unit described above (not illustrated). The camera system control circuit 5 also includes an unillustrated image stabilizing control unit. The image stabilizing control unit generates a target value of the image stabilizing mechanism 14 from a signal of the shake detector 15 and performs drive control. The camera system control circuit 5 controls the state of each segment of an information display apparatus that performs information display by the display unit 9. The rear display apparatus 9a is a touch panel and is connected to the operation detector 10.

The camera system control circuit 5 includes a control unit 5a and a selector 5b. The control unit 5a controls the first image stabilizing unit and the second image stabilizing unit. The selector 5b selects whether to perform a specific operation using either the first image stabilizing unit or the second image stabilizing unit, according to the exposure time (shutter speed). An example of the specific operation includes an image stabilizing operation, a super-resolution operation, an LPF operation, or the like, as described later, but is not limited to this example.

The display unit 9 turns off the rear display apparatus 9a and presents information using the EVF 9b in a case where the user peeps through the EVF 9b, and presents information using the rear display apparatus 9a in a case where the user does not peep through the EVF 9b. The number of pixels and viewing magnification are each different between the rear display apparatus 9a and the EVF 9b, and designed image quality and the like are different. Thus, reading from the image sensor 6 or subsequent image processing is different as described later.

A description will now be given of an adjustment operation of an optical system by a control system. The image processing unit 7 is connected to the camera system control circuit 5 and calculates a proper focal position and aperture value (F-number) based on a signal from the image sensor 6. More specifically, the camera system control circuit 5 performs photometry (light metering) and distance measurement operations based on a signal from the image sensor 6 and determines exposure conditions (such as F-number, shutter speed, and ISO speed).

The camera system control circuit 5 outputs a command signal to the lens system control circuit 12 through the electric contact point 11. The lens system control circuit 12 properly controls the lens drive unit 13. In an image stabilizing mode, the camera system control circuit 5 properly controls an image stabilizing lens through the lens drive unit 13 based on a signal obtained from the image sensor 6 to be described later.

A brief description will now be given of a control flow of an image stabilizing unit according to this embodiment. In this embodiment, the image stabilizing unit includes the shake detector 15 configured to detect a shake, the image stabilizing mechanism 14 configured to perform an image stabilizing operation (image plane stabilization), and the image stabilizing control unit provided in the camera system control circuit 5. The operation detector 10 detects an operation (S1) of entering an imaging preparation operation when the unillustrated shutter release button is half-pressed. This corresponds to an aiming operation of determining the so-called composition. At this time, image plane stabilization is performed by using the image stabilizing mechanism 14 to facilitate composition determination. More specifically, the image stabilizing mechanism 14 based on a signal from the shake detector 15 is properly controlled to achieve image stabilization. Thereafter, the operation detector 10 detects an operation (S2) of entering an imaging operation when the shutter release button is fully pressed. At this time, image plane stabilization is performed by using the image stabilizing mechanism 14 to reduce the blur of an object image acquired through exposure. The image stabilizing operation is stopped when a certain time elapses after the exposure.

Next, the image sensor 6 according to this embodiment will be described below. The image sensor 6 can output images in a variety of formats, such as so-called a still image and a moving image. Moving images have a plurality of formats, and the aspect ratio, recording image resolution, and the like can be changed. The image sensor 6 has a mode (such as HDR or noise reduction) in which temporally consecutive still images are acquired and combined. In other words, the image sensor 6 may acquire images in a temporally consecutive manner irrespective of whether they are still images or moving images.

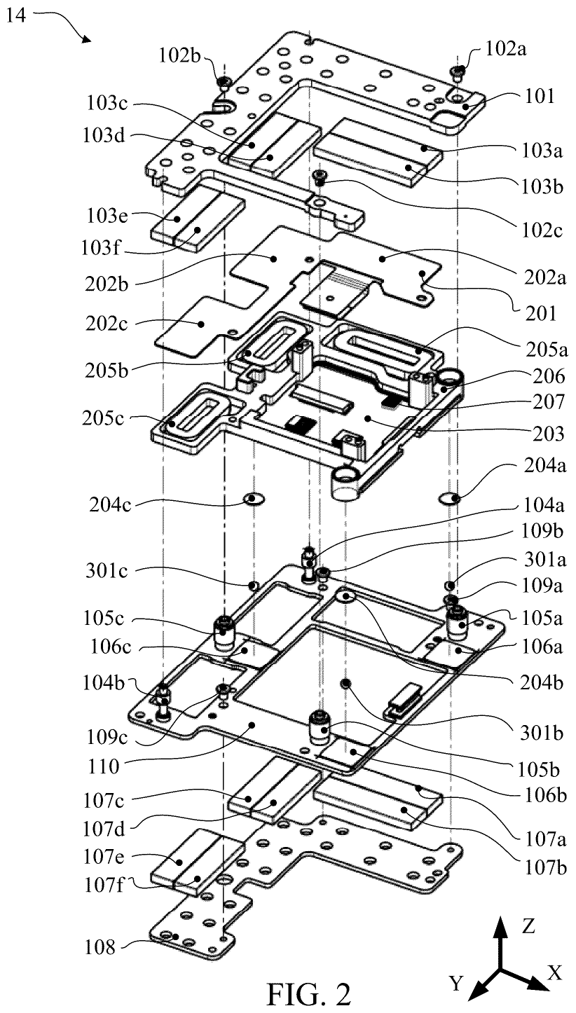

Referring now to FIG. 2, a description will be given of the image stabilizing mechanism (image plane stabilization mechanism) 14 according to this embodiment. FIG. 2 is an exploded perspective view of a mechanism that performs image stabilization of a low-frequency shake in the image stabilizing mechanism 14 (excluding an electric mechanism that performs separate control). In FIG. 2, vertical lines are parallel to the optical axis 4. In FIG. 2, members (fixed units) that do not move will be designated by numbers in the 100s, members (movable units) that are to move will be denoted by numbers in the 200s, and balls sandwiched between the fixed and movable units are denoted by numbers in the 300s.

In FIG. 2, reference numeral 101 denotes an upper yoke, reference numerals 102a, 102b, and 102c denote screws, reference numerals 103a, 103b, 103c, 103d, 103e, and 103f denote upper magnets, reference numerals 104a and 104b denote auxiliary spacers, and 105a, 105b, and 105c denote main spacers. Reference numerals 106a, 106b, and 106c denote fixed unit rolling plates, and reference numerals 107a, 107b, 107c, 107d, 107e, and 107f denote lower magnets, reference numeral 108 denotes a lower yoke, reference numerals 109a, 109b, and 109c denote screws, and reference numeral 110 denotes a base plate. Reference numeral 201 denotes a flexible printed circuit (FPC), and reference numerals 202a, 202b, and 202c denote position detecting element attachment positions. Reference numeral 203 denotes a movable frame (movable printed circuit board (PCB)), reference numerals 204a, 204b, and 204c denote movable unit rolling plates, reference numerals 205a, 205b, and 205c denote coils, reference numerals 206 denotes a movable frame, and reference numerals 301a, 301b, and 301c denote balls. Reference numeral 207 denotes a piezoelectric element and is a unit configured to move the image sensor 6 at high speed.

The upper yoke 101, the upper magnets 103a, 103b, 103c, 103d, 103e, and 103f, the lower magnets 107a, 107b, 107c, 107d, 107e, and 107f, and the lower yoke 108 form a magnetic circuit and constitute a so-called closed magnetic path. The upper magnets 103a, 103b, 103c, 103d, 103e, and 103f are adhered and fixed in a state of being attracted to the upper yoke 101. Similarly, the lower magnets 107a, 107b, 107c, 107d, 107e, and 107f are adhered and fixed in a state of being attracted to the lower yoke 108. The upper magnets 103a, 103b, 103c, 103d, 103e, and 103f and the lower magnets 107a, 107b, 107c, 107d, 107e, and 107f are each magnetized in an optical axis direction (up-down direction in FIG. 2). Among them, adjacent magnets (in the positional relation between the upper magnets 103a and 103b) are magnetized in different directions. In addition, opposing magnets (in a positional relation between the upper magnet 103a and the lower magnet 107a) are magnetized in the same direction. Thereby, a magnetic flux density that is strong in the optical axis direction is generated between the upper yoke 101 and the lower yoke 108.

A strong attraction force is generated between the upper yoke 101 and the lower yoke 108. Thus, proper spacing is maintained by the main spacers 105a, 105b, and 105c and the auxiliary spacers 104a and 104b. The proper spacing is a gap or distance that is sufficient to dispose the coils 205a, 205b, and 205c and the FPC 201 between the upper magnets 103a to 103f and the lower magnets 107a to 107f and ensure proper air gap. The main spacers 105a, 105b, and 105c are provided with screw holes, and the upper yoke 101 is fixed to the main spacers 105a, 105b, and 105c by the screws 102a, 102b, and 102c. Rubber is provided on body portions of the main spacers 105a, 105b, and 105c, forming mechanical end portions (what are called stoppers) of movable units.

The base plate 110 includes holes to avoid the lower magnets 107a, 107b, 107c, 107d, 107e, and 107f such that the surfaces of magnets protrude through the holes. More specifically, the base plate 110 and the lower yoke 108 are fixed by the screws 109a, 109b, and 109c, and the lower magnets 107a to 107f having larger dimensions in the thickness direction than the base plate 110 are fixed so as to protrude from the base plate 110.

The movable frame 203 is made of magnesium die-cast material or aluminum die-cast material and is lightweight and highly rigid. Elements of a movable unit are fixed to the movable frame 203 to constitute the movable unit. A position detecting element is attached to the surface of the FPC 201 on a side that is invisible in FIG. 2 at positions indicated by the position detecting element attachment positions 202a, 202b, and 202c. For example, a Hall element may be used to allow position detection using the above-described magnetic circuit. The Hall element has a small size and thus is disposed so as to be nested inside windings of the coils 205a, 205b, and 205c.

The movable frame 203 is connected to the unillustrated image sensor 6, coils 205a, 205b, and 205c, and Hall element. Electric communication with the outside is performed through connectors on the movable frame 203.

The fixed unit rolling plates 106a, 106b, and 106c are adhered and fixed to the base plate 110, and the movable unit rolling plates 204a, 204b, and 204c are adhered and fixed to the movable frame 203, forming roll surfaces of the balls 301a, 301b, and 301c. Since the rolling plates are separately provided, it is easy to design desirable states such as surface roughness and hardness.

In a case where current is supplied to the coils in the above configuration, force is generated in accordance with Fleming's left-hand rule and the movable unit can be moved. In addition, feedback control can be performed using a signal from the Hall element as the position detecting element. Properly controlling the signal value from the Hall element can translate the movable frame 203 in a plane orthogonal to the optical axis 4 and rotate the movable frame 203 about the optical axis.

Rotational motion approximately about the optical axis 4 can be generated by maintaining constant the signal from the Hall element at the position detecting element attachment position 202a while driving the Hall element signal at the position detecting element attachment positions 202b and 202c in opposite phases.

A magnetic flux density in the optical axis direction is detected at the position detecting element attachment positions 202a, 202b, and 202c. The characteristic of the magnetic circuit including the upper magnets 103a, 103b, 103c, 103d, 103e, and 103f, the lower magnets 107a, 107b, 107c, 107d, 107e, and 107f, and the like is generally nonlinear. Thus, the magnetic flux density detected at the position detecting element attachment positions 202a, 202b, and 202c does not necessarily have a constant resolution in the entire drive range (the detection resolution varies). More specifically, there are positions where a change in the magnetic flux density is steep and positions where it is moderate, and the detection resolution is higher (magnetic flux density change relative to a moving amount is larger) at positions where the change is steeper. In the magnetic circuit illustrated in FIG. 2, the change in the magnetic flux density is largest at boundary positions between magnets (for example, a boundary position between the upper magnets 103a and 103b), and the detection resolution is highest there. A large number of proposals have been made regarding details of a control method, and thus a detailed description thereof will be omitted.

The image stabilizing mechanism 14 includes the image stabilizing mechanism 207 configured to correct shakes up to frequencies higher than those of the image stabilizing mechanism 14 illustrated in FIG. 2. In a mechanism that corrects a low-frequency shake, force is generated in accordance with Fleming's left-hand rule by supplying current to a coil, thereby moving the movable unit. On the other hand, the image stabilizing mechanism 207 can correct up to a high-frequency shake by moving the movable unit using a piezoelectric element. Hereinafter, a mechanism that corrects a high-frequency shake will be referred to as a high-speed image stabilizing mechanism. The mechanism that corrects a high-frequency shake as well has a small stroke. Hereinafter, a mechanism that corrects a low-frequency shake will be referred to as a low-speed image stabilizing mechanism. The mechanism that corrects a low-frequency shake has a stroke longer than that of the high-speed image stabilizing mechanism. The method of moving the movable unit is not limited to a method using a piezoelectric element but may be another method.

In this embodiment, the image pickup apparatus 1 includes a plurality of image stabilizing mechanisms, but the present disclosure is not limited to this embodiment and the lens apparatus 2 may include a plurality of image stabilizing mechanisms. In the imaging system 100, for example, a total of four image stabilizing mechanisms can include two image stabilizing mechanisms in the image pickup apparatus 1 and two image stabilizing mechanisms in the lens apparatus 2, and their numbers can be each decreased or increased in combination.

Super-resolution is a function to increase resolving power by moving an image stabilizing mechanism by a minute amount less than one pixel and combining images, and the function is widely known. The super-resolution method is not limited.

The low-speed image stabilizing mechanism corresponds to the first image stabilizing unit. The high-speed image stabilizing mechanism corresponds to the second image stabilizing unit. The image stabilization operation (image stabilizing operation) corresponds to a first operation. The super-resolution operation corresponds to a second operation. An exposure time (predetermined time) as a reference for switching the image stabilizing mechanisms is a duration in which high-frequency hand shake is no longer dominant, and is often 1/focal length seconds approximately. The predetermined time may be determined based on balance with image stabilizing performance or difference in shaking characteristics among individuals.

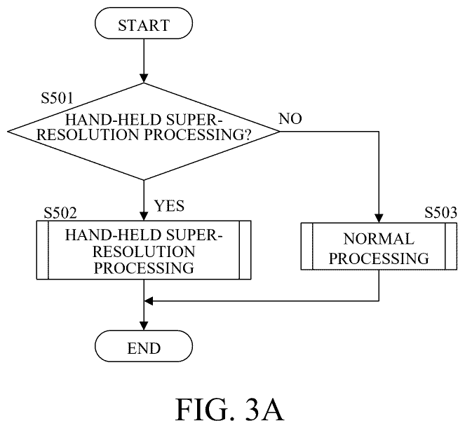

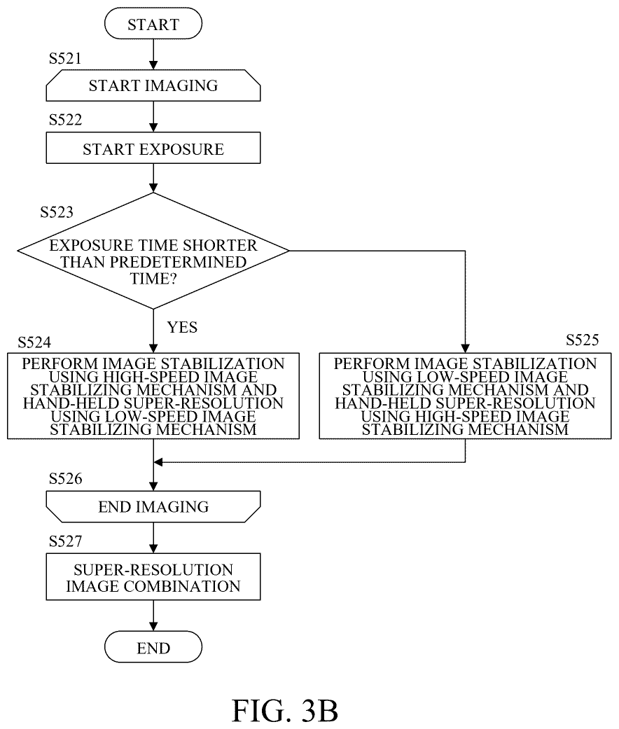

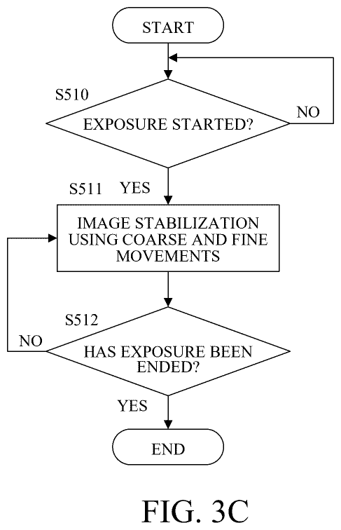

Referring now to FIGS. 3A to 3C, a description will be given of the image stabilizing operation (control method) in the image pickup apparatus 1 and the lens apparatus 2. FIGS. 3A, 3B, and 3C are flowcharts illustrating the control method according to this embodiment.

First, in step S501 in FIG. 3A, the camera system control circuit 5 determines whether to perform hand-held super-resolution processing. In a case where it is determined that the hand-held super-resolution processing is to be performed, the flow proceeds to step S502. In a case where it is determined that the hand-held super-resolution processing is not to be performed, the flow proceeds to step S503. In step S502, the camera system control circuit 5 performs the hand-held super-resolution processing. Details of the hand-held super-resolution processing (alignment image combination processing in step S502) will be described below with reference to FIG. 3B. In step S503, the camera system control circuit 5 performs normal processing. Details of the normal processing (step S503) will be described below with reference to FIG. 3C.

In step S521 in FIG. 3B, the camera system control circuit 5 starts hand-held super-resolution imaging. Next in step S522, the camera system control circuit 5 starts exposure. Next in step S523, the camera system control circuit 5 determines whether the exposure time is short or long (for example, whether the exposure time is shorter than the predetermined time). The threshold value (predetermined time) for determining that the exposure time is short is determined in accordance with performance of each of the low-speed image stabilizing mechanism and the high-speed image stabilizing mechanism, the focal length, and the like. In this embodiment, the threshold value is determined based on “1/focal length” approximately, but is not limited to this example. In a case where it is determined that the exposure time is shorter than the predetermined time, the flow proceeds to step S524. In a case where it is determined that the exposure time is not shorter than the predetermined time, the flow proceeds to step S525.

In step S524, the camera system control circuit 5 performs the image stabilization using the high-speed image stabilizing mechanism and performs the hand-held super-resolution using the low-speed image stabilizing mechanism. In step S525, the camera system control circuit 5 performs the image stabilization using the low-speed image stabilizing mechanism and performs the hand-held super-resolution using the high-speed image stabilizing mechanism. After end of step S524 or S525, the flow proceeds to step S526.

In step S526, in a case where all scheduled imaging has been completed, the camera system control circuit 5 ends imaging and the flow proceeds to step S527. In a case where not all imaging has been completed, the flow returns to step S522 to perform the remaining exposure. In step S527, captured images are combined with slight shifts to generate a super-resolution image (super-resolution image combination).

FIG. 3C is a flowchart of the normal processing (S503). The normal processing described in this embodiment is merely illustrative and may be other processing. First, in step S510, the camera system control circuit 5 determines whether exposure has been started. In a case where it is determined that exposure has not been started, the determination in step S510 is repeated. In a case where it is determined that exposure has been started, the flow proceeds to step S511.

In step S511, the camera system control circuit 5 performs the image stabilization using the low-speed image stabilizing mechanism and the high-speed image stabilizing mechanism. Next in step S512, the camera system control circuit 5 determines whether exposure has been ended. In a case where it is determined that exposure has not been ended, step S511 is repeated. In a case where it is determined that exposure has been ended, this flow ends.

The above switching control is performed as described above in a case where one high-speed image stabilizing mechanism and one low-speed image stabilizing mechanism are provided (in a case where two image stabilizing mechanisms are provided). A case where three or more image stabilizing mechanisms are provided will be described below.

As one example with a plurality of combinations, the image pickup apparatus 1 may include a high-speed image stabilizing mechanism and a low-speed image stabilizing mechanism, and the lens apparatus 2 may include a high-speed image stabilizing mechanism and a low-speed image stabilizing mechanism (a total of four image stabilizing mechanisms may be provided). In another example, the image pickup apparatus 1 includes a high-speed image stabilizing mechanism and a low-speed image stabilizing mechanism, and the lens apparatus 2 includes a low-speed image stabilizing mechanism (a total of three image stabilizing mechanisms may be provided). In another example, the image pickup apparatus 1 may include a low-speed image stabilizing mechanism, and the lens apparatus 2 may include a high-speed image stabilizing mechanism and a low-speed image stabilizing mechanism (a total of three image stabilizing mechanisms may be provided). In another example, the image pickup apparatus 1 may include a high-speed image stabilizing mechanism and a low-speed image stabilizing mechanism, and the lens apparatus 2 may include a high-speed image stabilizing mechanism, or they may have opposite configurations. In a case where a total of two image stabilizing mechanisms are provided, a high-speed image stabilizing mechanism and a low-speed image stabilizing mechanism may be provided in the lens apparatus 2 or the image pickup apparatus 1. Alternatively, the image pickup apparatus 1 may include a high-speed image stabilizing mechanism, and the lens apparatus 2 may include a low-speed image stabilizing mechanism, or they may have opposite configurations. High-speed image stabilizing mechanisms and low-speed image stabilizing mechanism may be provided in any other combination not described in this embodiment.

A description will now be given of switching control in the case of a total of four image stabilizing mechanisms, in which the image pickup apparatus 1 includes a high-speed image stabilizing mechanism and a low-speed image stabilizing mechanism, and the lens apparatus 2 includes a high-speed image stabilizing mechanism and a low-speed image stabilizing mechanism.

In a case where the exposure time is long, the image stabilization is performed using the low-speed image stabilizing mechanism of the lens apparatus 2. In a case where the exposure time is short, the image stabilization is performed using the high-speed image stabilizing mechanism the lens apparatus 2. The image stabilization with rotation about the optical axis is performed by using the high-speed image stabilizing mechanism of the image pickup apparatus 1 in either case where the exposure time is short or long.

In a case where the exposure time is long, super-resolution processing is performed by using the low-speed image stabilizing mechanism of the lens apparatus 2. In a case where the exposure time is short, super-resolution processing is performed by using either the high-speed image stabilizing mechanism of the lens apparatus 2 or the high-speed image stabilizing mechanism of the image pickup apparatus 1.

The image stabilization during aiming is performed by using either the high-speed image stabilizing mechanism of the lens apparatus 2 or the high-speed image stabilizing mechanism of the image pickup apparatus 1. Typically, in a case where the focal length is long, a stroke of the image stabilizing mechanism of the lens apparatus 2 is longer than a correction angle of the image stabilizing mechanism of the image pickup apparatus 1. Thus, in a case where the exposure time is short, usage of the image stabilizing mechanisms may be switched so that the stroke during aiming is longer, and the remaining image stabilizing mechanism may be used for super-resolution processing, thereby enabling a longer stroke during aiming. In a case where the focal length is short, the stroke of the image stabilizing mechanism of the image pickup apparatus 1 is longer than the stroke of the image stabilizing mechanism of the lens apparatus 2. In a case where the exposure time is short, influence of a high-frequency hand shake is significant and thus the image stabilization is performed by using the high-speed image stabilizing mechanism. Thereby, a high-frequency hand shake can be properly corrected.

In a case where the exposure time is long, the image stabilization for a hand shake having a larger amplitude than a high-frequency hand shake is dominant. Thus, it is possible to highly accurately perform the image stabilization by performing the image stabilization using the low-speed image stabilizing mechanism. Since rotation about the optical axis can be corrected only by using the image stabilizing mechanism of the image pickup apparatus 1, correction is performed by using the high-speed image stabilizing mechanism of the image pickup apparatus 1. Thereby, a high-frequency hand shake can be corrected as well. In this manner, the switching control over the image stabilizing mechanisms in accordance with such characteristics can correct a high-frequency hand shake in a case where the exposure time is short, and a large-amplitude hand shake in a case where the exposure time is long. Moreover, since an image stabilizing mechanism that is not used for the image stabilization and super-resolution is used for image stabilization during aiming and the image stabilization against rotation about the optical axis, the imaging ease and the image stabilization performance improve. This switching control can achieve highly accurate hand-held super-resolution irrespective of the exposure time.

A description will now be given of a switching control in a case where the lens apparatus 2 includes a low-speed image stabilizing mechanism and the image pickup apparatus 1 includes a high-speed image stabilizing mechanism and a low-speed image stabilizing mechanism (three image stabilizing mechanisms are provided).

In a case where the exposure time is short, the image stabilization is performed using the high-speed image stabilizing mechanism of the image pickup apparatus 1. In a case where the exposure time is long and the focal length is long, the image stabilization is performed using the low-speed image stabilizing mechanism of the lens apparatus 2. In a case where the exposure time is long and the focal length is short, the image stabilization is performed using the low-speed image stabilizing mechanism of the image pickup apparatus 1. In a case where the exposure time is short and the focal length is long, super-resolution is performed using the low-speed image stabilizing mechanism of the lens apparatus 2. In a case where the exposure time is short and the focal length is short, super-resolution is performed using the low-speed image stabilizing mechanism of the image pickup apparatus 1. In a case where the exposure time is long, super-resolution is performed using the high-speed image stabilizing mechanism of the image pickup apparatus 1. During aiming, correction is performed using the low-speed image stabilizing mechanism of the image pickup apparatus 1 in a case where the focal length is long, and correction is performed using the low-speed image stabilizing mechanism of the lens apparatus 2 in a case where the focal length is short.

The image stabilization is performed using the high-speed image stabilizing mechanism in a case where the exposure time is short, and the image stabilization is performed using the low-speed image stabilizing mechanism in a case where the exposure time is long. Thereby, it is possible to correct a high-frequency hand shake that is dominant in a case where the exposure time is short, and it is possible to correct a large-amplitude hand shake that is dominant in a case where the exposure time is long. Moreover, since an image stabilizing mechanism that is not used for image stabilization is used for image stabilization during aiming, the imaging ease can be improved.

A description will now be given of a switching control in a case where the lens apparatus 2 includes a high-speed image stabilizing mechanism and a low-speed image stabilizing mechanism and the image pickup apparatus 1 includes a low-speed image stabilizing mechanism (three image stabilizing mechanisms are provided).

The image stabilization is performed using the high-speed image stabilizing mechanism in the lens apparatus 2 in a case where the exposure time is short, and the image stabilization is performed using the low-speed image stabilizing mechanism of the lens apparatus 2 in a case where the exposure time is long and the focal length is long. In a case where the exposure time is long and the focal length is short, the image stabilization is performed using the low-speed image stabilizing mechanism of the image pickup apparatus 1. In a case where the exposure time is short and the focal length is long, super-resolution is performed using the low-speed image stabilizing mechanism of the lens apparatus 2. In a case where the exposure time is short and the focal length is short, super-resolution is performed using the low-speed image stabilizing mechanism of the image pickup apparatus 1. In a case where the exposure time is long, super-resolution is performed using the high-speed image stabilizing mechanism in the lens apparatus 2. During aiming, correction is performed using the low-speed image stabilizing mechanism of the image pickup apparatus 1 in a case where the focal length is long, and correction is performed using the low-speed image stabilizing mechanism of the lens apparatus 2 in a case where the focal length is short.

The image stabilization is performed using the high-speed image stabilizing mechanism in a case where the exposure time is short, and the image stabilization is performed using the low-speed image stabilizing mechanism in a case where the exposure time is long. Thereby, it is possible to correct a high-frequency hand shake that is dominant in a case where the exposure time is short, and it is possible to correct a large-amplitude hand shake that is dominant in a case where the exposure time is long. Moreover, since any image stabilizing mechanism that is not used for the image stabilization is used for shake correction during aiming, the imaging ease can be improved.

In a case where the first operation and the second operation are performed using a plurality of image stabilizing mechanisms (image stabilizing units), this embodiment can properly execute both the first operation and the second operation by changing which image stabilizing mechanisms to be used among the plurality of image stabilizing mechanisms, according to the exposure time.

### Second Embodiment

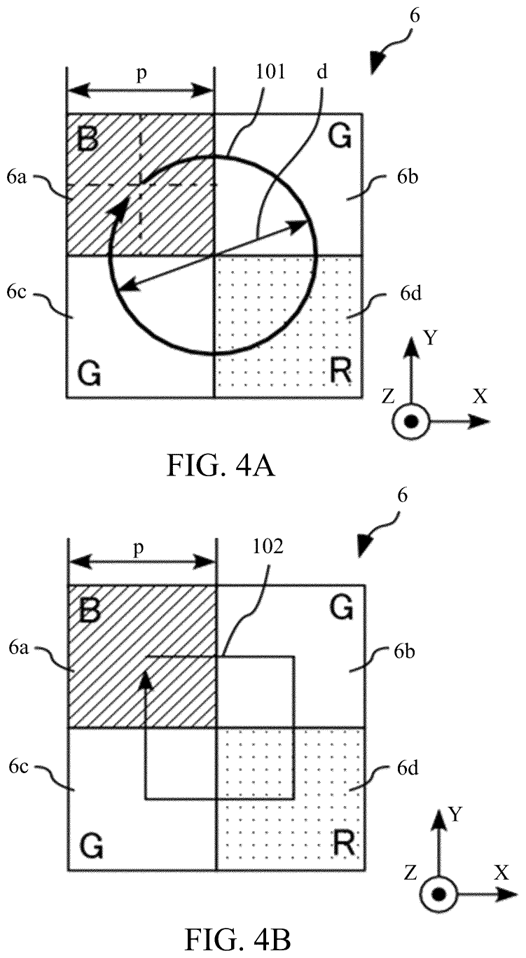

A second embodiment of the present disclosure will be described below with reference to FIGS. 4A to 6. This embodiment will discuss LPF drive (low-pass filter operation) using the image stabilizing mechanism 14. The LPF drive is operation of achieving an optical LPF effect by moving an image stabilizing unit by a minute amount to allow an object light beam to enter a plurality of pixels of the image sensor 6. The basic configuration of the imaging system according to this embodiment is similar to that of the imaging system 100 in the first embodiment described with reference to FIGS. 1A and 1i, and thus a description thereof will be omitted.

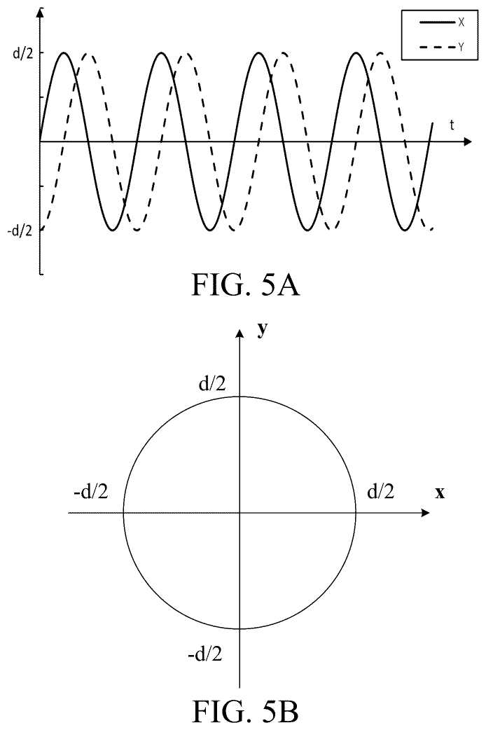

FIGS. 4A and 4B explain the LPF operation, illustrating an enlarged view of an image sensor unit (pixel unit) of the image sensor 6. FIGS. 4A and 4B illustrate only four pixels of a B pixel 6a, a G pixel 6b, a G pixel 6c, and a R pixel 6d. FIGS. 5A and 5B are graphs illustrating the drive amount of the image stabilizing mechanism 14. FIG. 5A illustrates temporal change in the drive amount of the image sensor 6 in each of an X direction and a Y direction, and FIG. 5B illustrates the drive amount with the X direction on the horizontal axis and the Y direction on the vertical axis.

In FIG. 4A, the four pixels are R, G, and B pixels with color filters disposed in a matrix at a pixel pitch p, and a plurality of pixels are repeatedly disposed in this pattern. In a case where the LPF drive is performed by using the image stabilizing mechanism 14, the image sensor 6 is moved at a constant speed in a circular arc shape with a diameter d as illustrated with circular arrow 101 in FIG. 4A. An operation of moving the image sensor 6 at a constant speed in a circular arc shape will be referred to as circle operation hereinafter. Arrow 101 passes through substantially the centers of the pixels 6a to 6d, and the diameter d is given by equation (1) below:

$$d = p / √ 2 \qquad ( 1 )$$

In a case where the arc operation described above is performed during still image exposure, a light beam that enters the B pixel 6a during non-operating time equally enters the pixels 6a to 6d. An optical LPF effect can be achieved by allowing an object light beam to enter a plurality of pixels of the image sensor (LPF operation).

In order to achieve the LPF effect, the circle operation may be performed by at least one cycle during still image during exposure time, and the circle operation may be performed by an integral multiple of the cycle the exposure time. Alternatively, in a case where the number of times of the circle operation is not an integer multiple, unevenness occurs due to difference in the light amount incident on the four pixels. However, as long as the circle operation is performed at a high frequency with a cycle sufficiently shorter than the exposure time, a difference in a light amount incident on each pixel decreases, and thus a sufficient LPF effect can be achieved. With high-frequency drive in the circle operation, the frequency of the circle operation may not be changed in accordance with on the exposure time, and thus control can be simplified.

Accordingly, this embodiment achieves the LPF effect by performing high-frequency circle operation drive in an LPF drive mode. In this embodiment, the circle diameter d of the circle operation has a value given by equation (1), but is not limited to this example. The LPF effect can be enhanced by increasing the diameter of the circle operation. For example, in a case where data is intermittently extracted from pixels among the pixels of the image sensor 6 for preview display on the display unit 9 before imaging exposure operation, the diameter d may be changed in accordance with, for example, the spacing of pixels from which data is to be intermittently extracted.

Alternatively, the LPF effect may be achieved by driving as illustrated in FIG. 4B. FIG. 4B illustrates another operation of the LPF drive, and similarly to FIG. 4A, illustrates only the four pixels 6a to 6d in an enlarged manner. In the LPF drive using the image stabilizing mechanism 14, the LPF effect can be achieved by moving the image sensor 6 at a constant speed in a square shape with a side length of p as illustrated with arrow 102 in FIG. 4B.

Referring now to FIGS. 5A and 5B, a description will be given of a method of driving the image stabilizing mechanism 14. In FIG. 5A, a drive amount for movement in the X direction by the image stabilizing mechanism 14 is illustrated with a solid line, and a drive amount for movement in the Y direction is illustrated with a broken line. In FIG. 5A, drive in the X direction is performed in a sine wave with an amplitude d/2 and a frequency f [Hz]. Drive in the Y direction is performed in a sine wave with a amplitude d/2 and a frequency f [Hz], but with a phase shifted from drive in the X direction by π/2. FIG. 5B illustrates, on an XY plane, movement of the center of the image sensor 6 in a case where the operation in FIG. 5A is performed. As illustrated in FIG. 5B, the image sensor 6 performs the circle operation with a radius d/2, which is motion as illustrated in FIG. 4A. The LPF effect can be achieved by driving the image stabilizing mechanism 14 in this manner, and such drive control to perform circle operation drive at high frequency is referred to as an LPF drive mode.

The LPF drive mode at the image stabilizing mechanism 14 has thus been described; the LPF drive mode at the lens drive unit 13 will be described below. In the LPF drive mode, the lens drive unit 13 shifts a shift lens in the X and Y directions to achieve drive in which a light beam that condenses to the pixel 6a in FIG. 4A moves as illustrated with arrow 101. This drive can achieve the LPF effect. Although the drive amount of the shift lens varies according to the moving sensitivity on the imaging surface against a moving amount of the shift lens, the circle operation is performed through sinusoidal drive in the X and Y directions as illustrated in FIG. 5A. The trajectory of a condensed light beam on the imaging surface is moved as illustrated with arrow 101 in FIG. 4A.

The LPF drive may be performed by either the image stabilizing mechanism 14 in the image pickup apparatus 1 or the lens drive unit 13 in the lens apparatus 2. In general, the LPF drive may use drive at a frequency higher than that of the normal image stabilization operation, and thus power consumption increases. Thus, simultaneously performing the image stabilization and the LPF drive may cause insufficient correction due to insufficient power. Accordingly, in one known method, the power consumption of the image stabilizing mechanism 14 and the power consumption of the lens drive unit 13 are compared, and the LPF drive is performed using the one with smaller power consumption during high-frequency drive.

On the other hand, as described above, the LPF drive may perform high-frequency drive with a cycle sufficient shorter than the exposure time. In such a case, if a drive method for performing the LPF drive is determined only from the perspective of power consumption, a sufficient LPF effect may not achieved. In other words, in a case where the exposure time is short, a drive method with good responsiveness during high-frequency drive (high-frequency drive characteristic) may be selected.

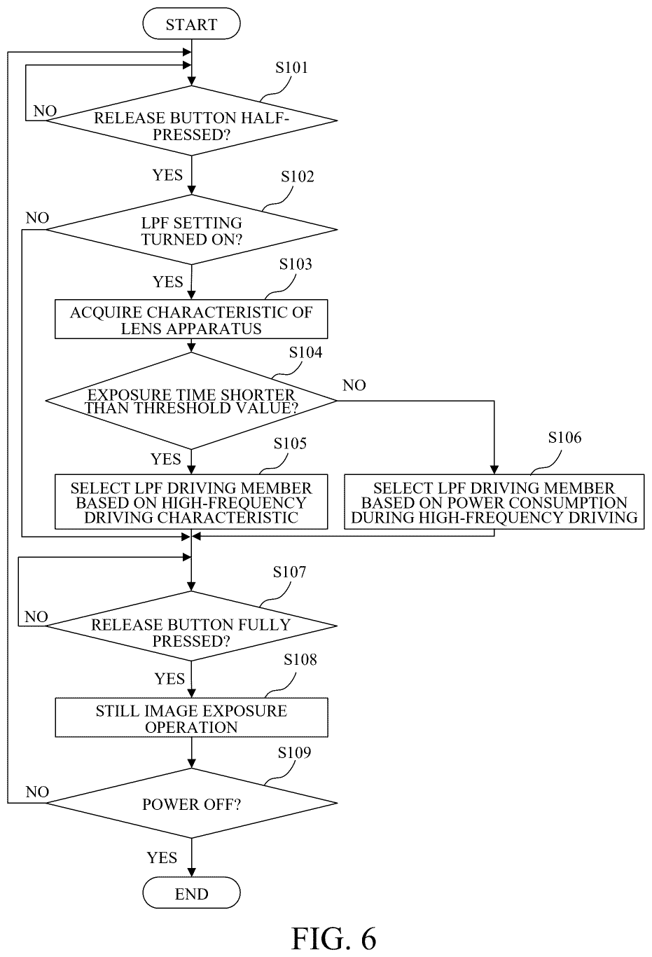

Accordingly, in determining a drive method for performing the LPF drive, this embodiment selects a drive method with a good high-frequency drive characteristic in a case where the exposure time is shorter than the predetermined time. A specific example will be described below with reference to FIG. 6.

FIG. 6 is a flowchart illustrating processing (LPF drive during still image capturing) in this embodiment. The image pickup apparatus 1 according to this embodiment has an LPF setting that is switchable upon a user operation in a menu. In a case where the LPF setting is turned on, the LPF effect can be achieved by the LPF drive for the image stabilizing units. In a case where the LPF setting is turned off, imaging without the LPF effect is performed without performing the LPF drive for the image stabilizing units. The user can switch between turning-on and turning-off of the LPF setting on a menu screen displayed on the display unit 9. The flow of FIG. 6 starts in a case where the image pickup apparatus 1 is powered on.

First, in step S101, the camera system control circuit 5 determines whether a half-pressing operation of the release button by the user has been detected by the operation detector 10. In a case where it is determined that the half-pressing operation of the release button has been detected, the flow proceeds to step S102. In a case where it is determined that the half-pressing operation of the release button has not been detected, step S101 is repeated until the half-press operation of the release button is detected.

In step S102, the camera system control circuit 5 determines whether the LPF setting is turned on. In a case where it is determined that the LPF setting is turned on, the flow proceeds to step S103. In a case where it is determined that the LPF setting is turned off, the flow proceeds to step S107.

In step S103, the camera system control circuit 5 acquires characteristic of the lens drive unit 13 in the lens apparatus 2 mounted on the image pickup apparatus 1. The acquired characteristic is a drive characteristic for high-frequency drive, power consumption during high-frequency drive, and the like but is not limited to this example as long as it is a characteristic of the lens apparatus 2.

Next in step S104, the camera system control circuit 5 determines whether the exposure time is shorter than a predetermined threshold value (predetermined time). In a case where it is determined that the exposure time is shorter than the threshold value, the flow proceeds to step S105. In a case where it is determined that the exposure time is not shorter than the threshold value, the flow proceeds to step S106.

In step S105, the camera system control circuit 5 compares the high-frequency drive characteristics of the image stabilizing mechanism 14 and the lens drive unit 13 and selects a moving member (LPF drive member, image stabilizing unit) for the LPF drive based on the comparison result.

In step S106, the camera system control circuit 5 compares the power consumptions of the image stabilizing mechanism 14 and the lens drive unit 13 during high-frequency drive and selects a moving member (LPF drive member, or image stabilizing unit) for the LPF drive based on the comparison result.

In step S107, the camera system control circuit 5 determines whether a fully pressing operation of the release button has been detected and a still image exposure command has been issued. In a case where it is determined that the fully pressing operation of the release button has been detected, the flow proceeds to step S108. In a case where it is determined that the fully pressing operation of the release button has not been detected, step S107 is repeated until the fully pressing operation of the release button is detected.

In step S108, the camera system control circuit 5 drives the shutter mechanism 16 and performs still image capturing exposure using the image sensor 6. In a case where the still image capturing exposure is performed, information stored in a drive characteristic memory in the camera system control circuit 5 is referred to and the drive member selected in step S105 or S106 is LPF-driven at a drive frequency in accordance with the exposure time during still image capturing. Thereby, even if no LPF is mounted, image quality degradation due to moire and false colors for an object having high spatial frequency components can be prevented.

Next in step S109, the camera system control circuit 5 determines whether power is turned off using the operation detector 10. In a case where it is determined that power is turned off, this flow ends. In a case where it is determined that power is not turned off, the flow returns to step S101.

As described above, in this embodiment, the camera system control circuit 5 selects whether to perform the LPF operation using either the first image stabilizing unit or the second image stabilizing unit, according to the exposure time. In a case where the exposure time is shorter than the predetermined time (in a case where the shutter speed is faster than the predetermined speed), the camera system control circuit 5 selects an image stabilizing unit with a good high-frequency drive characteristic. In a case where the exposure time is longer than the predetermined time (in a case where the shutter speed is slower than the predetermined speed), the camera system control circuit 5 selects an image stabilizing unit with lower power consumption during high-frequency drive. Thereby, this embodiment can achieve a proper LPF effect even when the exposure time is short (the shutter speed is fast), while suppressing power consumption.

### Third Embodiment

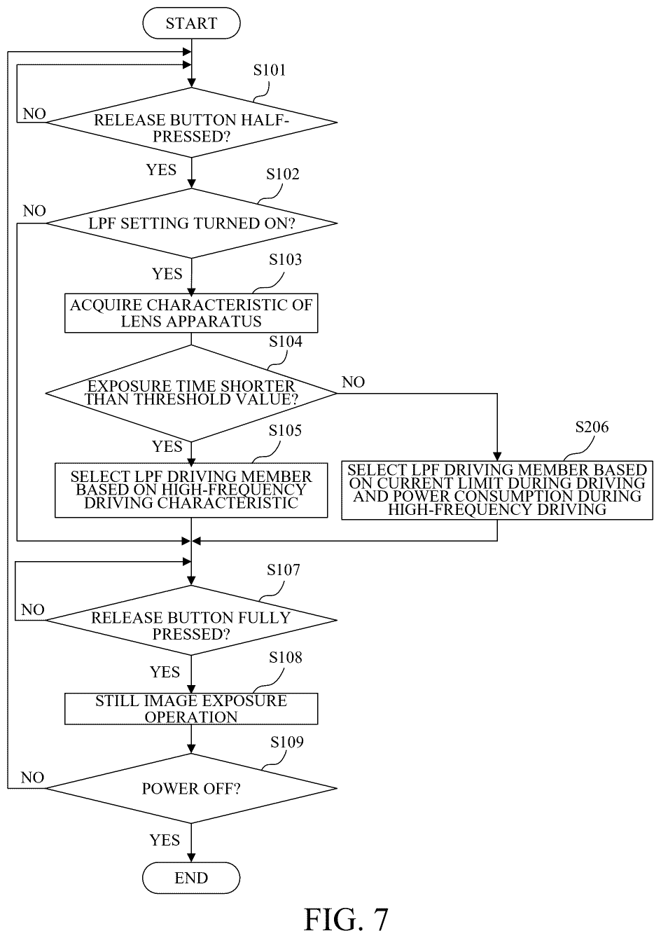

A third embodiment of the present disclosure will be described below with reference to FIG. 7. The basic configuration of the imaging system according to this embodiment is similar to that of the imaging system 100 in the first embodiment described with reference to FIGS. 1A and 1i, and thus a description thereof will be omitted.

The power of the lens apparatus 2 is supplied from the image pickup apparatus 1. Therefore, the drive unit in the lens apparatus 2 generally has a lower current limit during drive than the image pickup apparatus 1. Thus, even when the power consumption of the lens drive unit 13 is lower in the LPF drive mode, the image stabilizing mechanism 14 in the image pickup apparatus 1 may be driven in the LPF drive mode from the perspective of the current limit in some cases.

Accordingly, in a case where the exposure time is longer than the predetermined time, this embodiment compares the power limits of the lens apparatus 2 and the image pickup apparatus 1 and the power consumptions of the lens drive unit 13 and the image stabilizing mechanism 14, and determines a drive method for performing the LPF drive. A specific example will be described below with reference to FIG. 7. FIG. 7 is a flowchart illustrating processing (LPF drive) according to this embodiment. FIG. 7 is different from FIG. 6 (second embodiment) in that step S206 is included in place of step S106 in FIG. 6. Other steps are similar to those of FIG. 6, and thus a description thereof will be omitted.

In step S206, the camera system control circuit 5 compares power limits during drive between the lens apparatus 2 and the image pickup apparatus 1. The camera system control circuit 5 also compares power consumptions during high-frequency drive between the image stabilizing mechanism 14 and the lens drive unit 13. Then, the camera system control circuit 5 selects a moving member (the image stabilizing mechanism 14 or the lens drive unit 13) for the LPF drive, based on the comparison results.

Even if no low-pass filter is mounted, this embodiment can prevent image quality degradation due to moire and false colors for an object having high spatial frequency components. Moreover, this embodiment can achieve a proper LPF effect according to the limit value of drive current, even when the exposure time is short (when the shutter speed is fast).

### Fourth Embodiment

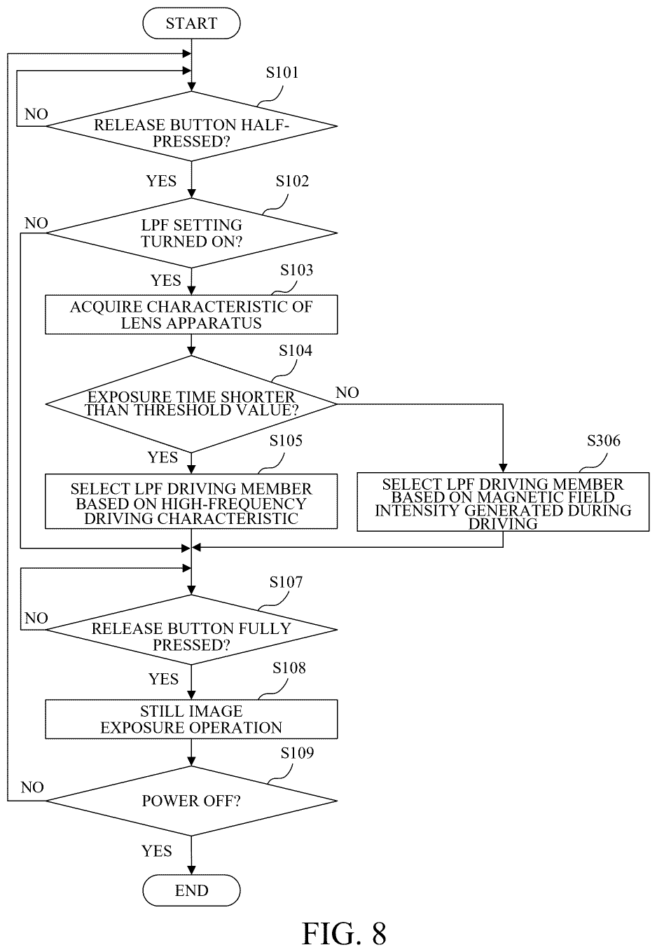

A fourth embodiment of the present disclosure will be described below with reference to FIG. 8. The basic configuration of the imaging system according to this embodiment is similar to that of the imaging system 100 in the first embodiment described with reference to FIGS. 1A and 1i, and thus a description thereof will be omitted.

There are a variety of types of image stabilizing mechanisms, and the intensity of magnetic field noise generated from an image stabilizing mechanism including an actuator varies according to a drive actuator type, a layout, and a drive mode. The magnetic field noise refers to a magnetic field emitted from the magnetic circuit of the image stabilizing mechanism, and image noise acquired by the image sensor 6 occurs when the magnetic field reaches the image sensor 6. The intensity of the magnetic field noise in this embodiment refers to the intensity of a magnetic field reaching the surface (imaging surface) of the image sensor 6. The magnetic field noise reaching the image sensor 6 is inversely proportional to a distance from the image sensor 6 and the magnetic circuit as a magnetic field source. For magnetic fields having the same intensity, the magnetic field noise reaching the image sensor 6 is stronger as the distance is shorter.

Hence, in a case where the lens drive unit 13 and the image stabilizing mechanism 14 emit magnetic field noise of the same intensity during the LPF drive, the magnetic field noise from the image stabilizing mechanism 14 closer to the image sensor 6 is shorter is stronger.

Accordingly, in a case where the exposure time is not shorter than the predetermined time and the intensities of magnetic fields generated by the lens drive unit 13 and the image stabilizing mechanism 14 in the LPF drive mode are similar, this embodiment selects the lens drive unit 13 farther from the image sensor 6 for the LPF drive mode. A specific example will be described below with reference to FIG. 8. FIG. 8 is a flowchart illustrating processing (LPF drive) according to this embodiment. FIG. 8 is different from FIG. 6 (second embodiment) in that step S306 is included in place of step S106 in FIG. 6. Other steps are similar to those of FIG. 6, and thus a description thereof will be omitted.

In step S306, the camera system control circuit 5 compares the intensities of magnetic fields generated by the image stabilizing mechanism 14 and the lens drive unit 13 during the LPF drive, and selects a moving member (the image stabilizing mechanism 14, the lens drive unit 13) for the LPF drive based on the comparison result.

Even when no LPF is mounted, this embodiment can prevent image quality degradation due to moire and false colors in an object having high spatial frequency parts. Moreover, this embodiment can achieve a proper LPF effect according to magnetic field noise generated during the LPF operation, even when the exposure time is short (when the shutter speed is fast).

Thus, in each embodiment, the selector 5b selects whether to perform a specific operation using either the first image stabilizing unit or the second image stabilizing unit, according to the exposure time (shutter speed). For example, the image stabilizing mechanism 14 includes at least one of the first image stabilizing unit and the second image stabilizing unit, and the lens drive unit 13 includes at least one of the first image stabilizing unit and the second image stabilizing unit.

The specific operation may include the first operation and the second operation. The control unit 5a may perform the first operation using one of the first image stabilizing unit and the second image stabilizing unit and the second operation different from the first operation, using the other of the first image stabilizing unit and the second image stabilizing unit. The first operation may be the image stabilizing operation, and the second operation may be an operation different from the image stabilizing operation. The first image stabilizing unit may correct a low-frequency shake signal, and the second image stabilizing unit may correct a shake signal having a frequency higher than that of the low-frequency shake signal to be corrected by the first image stabilizing unit. The second image stabilizing unit may have a stroke shorter than that the first image stabilizing unit and a drivable frequency higher than that of the first image stabilizing unit.

The second operation may be a super-resolution operation. In a case where the exposure time is shorter than the predetermined time, the selector 5b may perform the super-resolution operation using the first image stabilizing unit and the image stabilizing operation using the second image stabilizing unit. In a case where the exposure time is longer than the predetermined time, the selector 5b may perform the image stabilizing operation using the first image stabilizing unit and the super-resolution operation using the second image stabilizing unit.

The specific operation may include an LPF operation. In a case where the exposure time is shorter than the predetermined time, the selector 5b may select whether to perform the LPF operation using the first image stabilizing unit or the second image stabilizing unit, according to responsiveness during high-frequency drive. In a case where the exposure time is longer than the predetermined time, the selector 5b may select whether to perform the low-pass filter operation using the first image stabilizing unit or the second image stabilizing unit, according to power consumption during high-frequency drive. In a case where the exposure time is longer than the predetermined time, the selector 5b may select whether to perform the low-pass filter operation using either the first image stabilizing unit or the second image stabilizing unit, according to the limit value of drive current. In a case where the exposure time is longer than the predetermined time, the selector 5b may select whether to perform the LPF operation using either the first image stabilizing unit or the second image stabilizing unit, according to magnetic field noise generated during the low-pass filter operation.

In the second to fourth embodiments, the selector 5b may select whether to perform the low-pass filter operation by using either the first image stabilizing unit or the second image stabilizing unit, according to the exposure time, but the present disclosure is not limited to this example. The selector 5b may switch whether to perform the image stabilizing operation or the LPF operation using either the first image stabilizing unit or the second image stabilizing unit, according to the exposure time. For example, in a case where the exposure time is shorter than the predetermined time, the selector 5b may perform the low-pass filter operation using the first image stabilizing unit and the image stabilizing operation using the second image stabilizing unit. In a case where the exposure time is longer than the predetermined time, the selector 5b may perform the image stabilizing operation using the first image stabilizing unit and the low-pass filter operation using the second image stabilizing unit.

In each embodiment, the predetermined time as a reference for switching between the first image stabilizing unit and the second image stabilizing unit may differ in accordance with at least one of a focal length, an F-number, and an ISO speed. Considering the focal length, the F-number, or the ISO speed can achieve further proper processing.

In each embodiment, the predetermined time may be variable based on a user setting. The configuration that can support a user preference can achieve proper processing for each user.

Each embodiment can provide a control apparatus, an image pickup apparatus, a control method, and a storage medium, each of which can more properly performing a specific operation.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-117749, which was filed on Jul. 23, 2024, and which is hereby incorporated by reference herein in its entirety.

What is claimed is:

1. A control apparatus comprising:
one or more memories storing instructions; and
one or more processors that, upon execution of the instructions, operate to:
control a first image stabilizing unit and a second image stabilizing unit, and
select whether to perform a specific operation using the first image stabilizing unit or the second image stabilizing unit according to an exposure time.

2. The control apparatus according to claim 1, wherein the specific operation includes a first operation and a second operation, and
wherein the one or more processors operate to:
perform the first operation by using one of the first image stabilizing unit and the second image stabilizing unit, and
perform the second operation different from the first operation using another of the first image stabilizing unit and the second image stabilizing unit.

3. The control apparatus according to claim 2, wherein the first operation is an image stabilizing operation, and
wherein the second operation is an operation different from the image stabilizing operation.

4. The control apparatus according to claim 2, wherein the first image stabilizing unit corrects a low-frequency shake signal, and
wherein the second image stabilizing unit corrects a shake signal having a frequency higher than that of the low-frequency shake signal to be corrected by the first image stabilizing unit.

5. The control apparatus according to claim 2, wherein the second image stabilizing unit has a stroke shorter than that of the first image stabilizing unit and has a drivable frequency higher than that of the first image stabilizing unit.

6. The control apparatus according to claim 3, wherein the second operation is a super-resolution operation.

7. The control apparatus according to claim 6, wherein in a case where the exposure time is shorter than a predetermined time, the one or more processors operate to perform the super-resolution operation using the first image stabilizing unit, and the image stabilizing operation using the second image stabilizing unit, and
wherein in a case where the exposure time is longer than the predetermined time, the one or more processors operate to perform the image stabilizing operation using the first image stabilizing unit and the super-resolution operation using the second image stabilizing unit.

8. The control apparatus according to claim 3, wherein the second operation is a low-pass filter operation.

9. The control apparatus according to claim 8, wherein in a case where the exposure time is shorter than a predetermined time, the one or more processors operate to perform the low-pass filter operation using the first image stabilizing unit and the image stabilizing operation using the second image stabilizing unit, and
wherein in a case where the exposure time is longer than the predetermined time, the one or more processors operate to perform the image stabilizing operation using the first image stabilizing unit and the low-pass filter operation using the second image stabilizing unit.

10. The control apparatus according to claim 2, wherein the specific operation includes a low-pass filter operation, and
wherein in a case where the exposure time is shorter than a predetermined time, the one or more processors operate to select whether to perform the low-pass filter operation using the first image stabilizing unit or the second image stabilizing unit according to responsiveness during high-frequency drive.

11. The control apparatus according to claim 10, wherein in a case where the exposure time is longer than the predetermined time, the one or more processors operate to select whether to perform the low-pass filter operation using the first image stabilizing unit or the second image stabilizing unit according to power consumption during the high-frequency drive.

12. The control apparatus according to claim 10, wherein in a case where the exposure time is longer than the predetermined time, the one or more processors operate to select whether to perform the low-pass filter operation using the first image stabilizing unit or the second image stabilizing unit according to a limit value of drive current.

13. The control apparatus according to claim 10, wherein in a case where the exposure time is longer than the predetermined time, the one or more processors operate to select whether to perform the low-pass filter operation using the first image stabilizing unit or the second image stabilizing unit according to magnetic field noise generated during the low-pass filter operation.

14. The control apparatus according to claim 7, wherein the predetermined time changes according to a focal length.

15. The control apparatus according to claim 7, wherein the predetermined time changes according to at least one of an F-number and an ISO speed.

16. The control apparatus according to claim 7, wherein the predetermined time is variable based on a user setting.

17. The control apparatus according to claim 1, wherein one or two first image stabilizing units are provided, and
wherein one or two second image stabilizing units are provided.

18. An image pickup apparatus comprising:
a control apparatus; and
an image sensor,
wherein the control apparatus includes:
one or more memories storing instructions; and
one or more processors that, upon execution of the instructions, operate to:
control a first image stabilizing unit and a second image stabilizing unit, and
select whether to perform a specific operation using the first image stabilizing unit or the second image stabilizing unit according to an exposure time.

19. A control method comprising:
controlling a first image stabilizing unit and a second image stabilizing unit, and
selecting whether to perform a specific operation using the first image stabilizing unit or the second image stabilizing unit according to an exposure time.

20. A non-transitory computer-readable storage medium storing a program that causes a computer to execute the control method according to claim 19.
